(19) United States
(12) Patent Application Publication
(10) Pub. No.: US 2012/0253746 A1
(43) Pub. Date: Oct. 4, 2012

(54) AUTONOMOUS DATA QUALITY EVALUATION

(75) Inventor: Harry R. Kolar, Scottsdale, AZ (US)

(73) Assignee: INTERNATIONAL BUSINESS MACHINES CORPORATION, Armonk, NY (US)

(21) Appl. No.: 13/073,094

(22) Filed: Mar. 28, 2011

(51) Int. Cl. G06F 15/00

(52) U.S. Cl. 702/188

(57) ABSTRACT

A solution for managing an asset is provided. A set of sensing devices associated with the asset are operated independent of a user to acquire sensor data. At least some of the sensor data is evaluated using a computer system associated with the asset to determine whether any sensor data in at least a portion of the sensor data is suspect. In response to a determination that at least a portion of the evaluated sensor data is suspect, an action is initiated by the computer system associated with the asset. The action can include adjusting additional processing of the sensor data, adjusting interaction between the computer system and at least one other system remote from the asset, and/or adjusting management operations of the asset.

### TECHNICAL FIELD

The disclosure relates generally to asset management, and more particularly, to autonomous evaluation of data quality for sensor data acquired on an asset that is deployed to a physical location for operation.

### BACKGROUND ART

Platforms that include various sensors for monitoring various aspects of a physical area are utilized in a variety of industries and applications. The sensors can include various combinations of one or more types of sensors having diverse technologies to measure physical, chemical, biological, radiological, and/or the like, characteristics of the surrounding environment. Such platforms can be located in water, in the air (e.g., using a balloon or aircraft), located in space, or located on land. Sensors and platforms can be stationary or moving. Illustrative industries and applications for water-based platforms include, but are not limited to: oceanography (e.g., research), port operations, river management, offshore oil and gas exploration and production, environmental monitoring and protection, ocean energy devices (wave and tidal), offshore wind farm monitoring, weather stations, aquaculture, marine biology, water quality, navigational aids, monitoring buoys, research platforms, flood control, mineral extraction (e.g., ocean mining), drilling platforms, etc. Platforms for land-based applications include, but are not limited to, roadway and traffic monitoring systems, internal and external building monitoring, distributed energy monitoring systems (generation, transmission, distribution, etc.), pipeline monitoring, structural monitoring (bridges, dikes, levees, and/or the like), security systems (video and/or acoustic monitoring), and/or the like.

These platforms are commonly left unattended, perform their desired operations autonomously or semi-autonomously, and report data to remote locations. Furthermore, a platform can be self-powered, e.g., using batteries that can be charged by various ambient energy sources, such as photovoltaic solar panels, wind-driven generators, energy harvesting devices (e.g., piezoelectric, thermal energy, etc.), water (e.g., current or flow) driven generators, and/or the like. In a typical deployment, multiple sensors can be connected to a small scale local or embedded computer system, which handles data sampling, collection, storage, and transmission of the sensor data.

A sensor on a platform can provide invalid or erroneous data (e.g., due to physical circumstances, sensor failure, associated component failures, and/or the like). In this case, the computer system will typically transmit the invalid sensor data for use in a larger monitoring/management system. In some instances, the monitoring/management system will process the data as valid sensor data, and initiate one or more actions that are not required. Furthermore, the data can be propagated to other systems, thereby requiring extensive time and effort to detect and correct the resulting data problem in the various systems.

### SUMMARY OF THE INVENTION

Aspects of the invention provide a solution for managing an asset. A set of sensing devices associated with the asset are operated independent of a user to acquire sensor data. At least some of the sensor data is evaluated using a computer system associated with the asset to determine whether any sensor data in at least a portion of the sensor data is suspect. In response to a determination that at least a portion of the evaluated sensor data is suspect, an action is initiated by the computer system associated with the asset. The action can include adjusting additional processing of the sensor data, adjusting interaction between the computer system and at least one other system remote from the asset, and/or adjusting management operations of the asset.

A first aspect of the invention provides a method of managing an asset, the method comprising: operating a set of sensing devices associated with the asset using a computer system associated with the asset to acquire sensor data, wherein the computer system operates the set of sensing devices independent of a user; evaluating at least a portion of the sensor data using the computer system, the evaluating including determining whether any sensor data in the at least a portion of the sensor data is suspect; and initiating an action using the computer system in response to determining at least a portion of the evaluated sensor data is suspect, wherein the action includes at least one of: adjusting additional processing of the sensor data, adjusting interaction between the computer system and at least one other system remote from the asset, or adjusting management operations of the asset.

A second aspect of the invention provides a system comprising: an asset deployed to a desired physical area; a set of input/output (I/O) devices associated with the asset, the set of I/O devices including a set of sensing devices for acquiring sensor data; a power system associated with the asset, wherein the power system is configured to provide all power for operating devices associated with the asset; and a computer system including at least one computing device associated with the asset, wherein the computer system is configured to manage the asset by performing a method including: operating the set of sensing devices independent of a user to acquire sensor data; evaluating at least a portion of the sensor data, the evaluating including determining whether any sensor data in the at least a portion of the sensor data is suspect; and initiating an action in response to determining at least a portion of the evaluated sensor data is suspect, wherein the action includes at least one of: adjusting additional processing of the sensor data, adjusting interaction between the computer system and at least one other system external to the asset, or adjusting management operations of the asset.

A third aspect of the invention provides a computer-readable storage medium comprising program code embodied therein, which when executed, causes a computer system to implement a method of managing an asset, the method comprising: operating a set of sensing devices associated with the asset to acquire sensor data independent of a user; evaluating at least a portion of the sensor data, the evaluating including determining whether any sensor data in the at least a portion of the sensor data is suspect; and initiating an action in response to determining at least a portion of the evaluated sensor data is suspect, wherein the action includes at least one of: adjusting additional processing of the sensor data, adjusting interaction between the computer system and at least one other system remote from the asset, or adjusting management operations of the asset.

A fourth aspect of the invention provides a method of deploying an asset, the method comprising: providing a computer system associated with the asset, wherein the computer system is configured to manage the asset by performing a method including: operating a set of sensing devices associated with the asset to acquire sensor data independent of a user; evaluating at least a portion of the sensor data, the evaluating including determining whether any sensor data in the at least a portion of the sensor data is suspect; and initiating an action in response to determining at least a portion of the evaluated sensor data is suspect, wherein the action includes at least one of: adjusting additional processing of the sensor data, adjusting interaction between the computer system and at least one other system remote from the asset, or adjusting management operations of the asset.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an illustrative environment including an asset according to an embodiment.

FIG. 2 shows an illustrative computer system comprising various components according to an embodiment.

FIG. 3 shows an illustrative flow diagram for evaluating sensor data acquired on an asset according to an embodiment.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide a solution for managing an asset. A set of sensing devices associated with the asset are operated independent of a user to acquire sensor data. At least some of the sensor data is evaluated using a computer system associated with the asset to determine whether any sensor data in at least a portion of the sensor data is suspect. In response to a determination that at least a portion of the evaluated sensor data is suspect, an action is initiated by the computer system associated with the asset. The action can include adjusting additional processing of the sensor data, adjusting interaction between the computer system and at least one other system remote from the asset, and/or adjusting management operations of the asset. In this manner, evaluation of the sensor data can be performed locally to the sensing devices, which can enable, among other things, a reduction (or elimination) in the transmission of suspect sensor data, power consumption by malfunctioning sensing devices, a complexity of processing required in systems remote from the asset, and/or the like. As used herein, unless otherwise noted, the term “set” means one or more (i.e., at least one) and the phrase “any solution” means any now known or later developed solution.

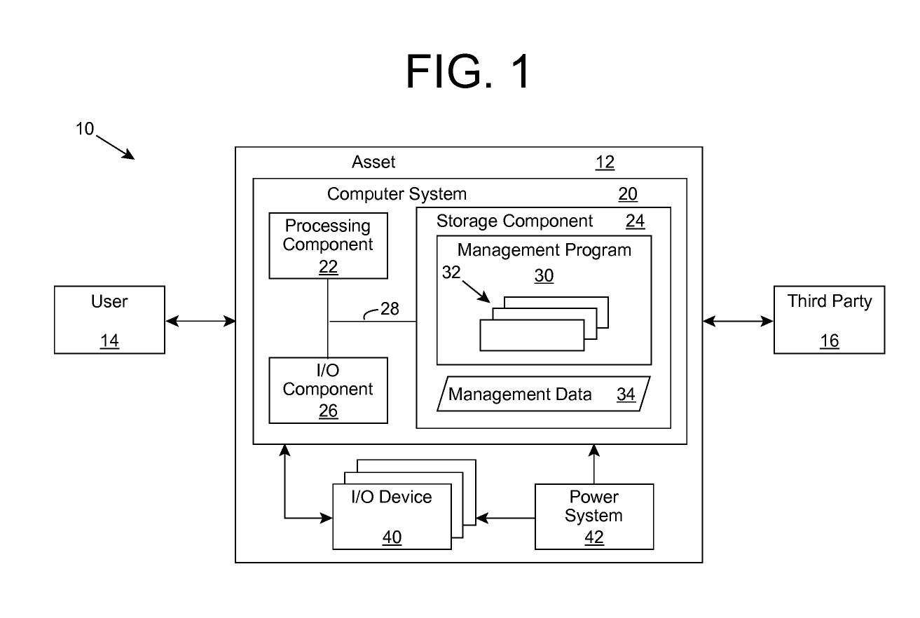

Turning to the drawings, FIG. 1 shows an illustrative environment 10 including an asset 12 according to an embodiment. To this extent, asset 12 includes a computer system 20 that can perform a process described herein in order to manage operation of various input/output (I/O) devices 40 on/associated with the asset 12. In particular, computer system 20 is shown including a management program 30, which makes computer system 20 operable to manage operation of the I/O devices 40 by performing a process described herein. As described herein, the asset 12 can provide/receive information to/from one or more users 14 and/or third parties 16. A user 14 or third party 16 can be a human, another machine, a service provided by another computer system, and/or the like.

Computer system 20 is shown including a processing component 22 (e.g., one or more processors), a storage component 24 (e.g., a storage hierarchy), an input/output (I/O) component 26 (e.g., one or more I/O interfaces and/or devices), and a communications pathway 28. In general, processing component 22 executes program code, such as management program 30, which is at least partially fixed in storage component 24. While executing program code, processing component 22 can process data, which can result in reading and/or writing transformed data from/to storage component 24 and/or I/O component 26 for further processing. Pathway 28 provides a communications link between each of the components in computer system 20. I/O component 26 can comprise one or more human I/O devices, which enable a human user 14 to interact with computer system 20 and/or one or more communications devices to enable a system (e.g., machine) user 14 to communicate with computer system 20 using any type of communications link. To this extent, management program 30 can manage a set of interfaces (e.g., graphical user interface(s), application program interface, and/or the like) that enable human and/or system users 14 to interact with management program 30. Further, management program 30 can manage (e.g., store, retrieve, create, manipulate, organize, present, etc.) the data, such as management data 34, using any solution.

In any event, computer system 20 can comprise one or more general purpose computing articles of manufacture (e.g., computing devices) capable of executing program code, such as management program 30, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, management program 30 can be embodied as any combination of system software and/or application software.

Further, management program 30 can be implemented using a set of modules 32. In this case, a module 32 can enable computer system 20 to perform a set of tasks used by management program 30, and can be separately developed and/or implemented apart from other portions of management program 30. As used herein, the term “component” means any configuration of hardware, with or without software, which implements the functionality described in conjunction therewith using any solution, while the term “module” means program code that enables a computer system 20 to implement the actions described in conjunction therewith using any solution. When fixed in a storage component 24 of a computer system 20 that includes a processing component 22, a module is a substantial portion of a component that implements the actions. Regardless, it is understood that two or more components, modules, and/or systems may share some/all of their respective hardware and/or software. Further, it is understood that some of the functionality discussed herein may not be implemented or additional functionality may be included as part of computer system 20.

When computer system 20 comprises multiple computing devices, each computing device can have only a portion of management program 30 fixed thereon (e.g., one or more modules 32). However, it is understood that computer system 20 and management program 30 are only representative of various possible equivalent computer systems that may perform a process described herein. To this extent, in other embodiments, the functionality provided by computer system 20 and management program 30 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 20 includes multiple computing devices, the computing devices can communicate over any type of communications link. Further, while performing a process described herein, computer system 20 can communicate with one or more other computer systems, such as user 14 or third party 16, using any type of communications link. In either case, the communications link can comprise any combination of various types of optical fiber, wired, and/or wireless links; comprise any combination of one or more types of networks; and/or utilize any combination of various types of transmission techniques and protocols.

As discussed herein, management program 30 enables computer system 20 to manage operations of a set of I/O devices 40 associated with an asset 12. In an embodiment, some or all of the set of I/O devices 40 are included on the asset 12 and are used for acquiring data regarding the environment within which the asset 12 is located. In another embodiment, the asset 12 acquires data from a set of I/O devices 40 that are physically located apart from the asset 12. When deployed for operations, the asset 12 can be moving, drifting, and/or secured to a physical area in water, the air, space, on land, and/or the like.

The data acquired by I/O devices 40 can comprise various types of measurement data, which can vary based on the I/O device 40 and/or the corresponding application for which the I/O device 40 is being utilized. Illustrative measurement data can include: data regarding the environment in which the I/O devices 40 is located, such as temperature, wind speed/direction, atmospheric pressure, humidity, presence/level of one or more compounds or contaminants, light level, visibility level, and/or the like; data regarding a body of water, such as a depth, current speed/direction, wave height, wave period, salinity, clarity, presence/level of one or more compounds or contaminants, and/or the like; etc. I/O devices 40 can acquire measurement data using any solution, and with any frequency. For example, an I/O device 40 can acquire and/or provide a measurement in response to receiving a request from computer system 20 and/or user 14, periodically according to a pre-defined time period, under autonomous decision making by computer system 20, and/or the like. The measurement data acquired by an I/O device 40 can comprise analog or digital data. Additionally, a group of I/O devices 40 can be configured to acquire the measurement data in serial, in parallel, synchronously, asynchronously, and/or the like. Regardless, computer system 20 can store data corresponding to the measurement data acquired by I/O device(s) 40 as management data 34.

An asset 12 also can include a location-sensing I/O device 40, which can acquire data on the location of the asset 12. In an embodiment, the location-sensing I/O device 40 comprises a global positioning system (GPS) communications device, or similar device. The location-sensing I/O device 40 can acquire two- or three-dimensional location data, which can be processed by computer system 20 to ensure that the asset 12 remains within the desired deployment area and/or to provide for processing by another system.

The set of I/O devices 40 can include one or more of various types of devices for communicating information to and/or receiving information from one or more users 14 and/or third parties 16. For example, the set of I/O devices 40 can include one or more signaling devices, such as a light (e.g., a beacon, strobe, and/or the like), a horn, and/or the like, which can signal to local third parties 16 (e.g., vessels or vehicles) the presence or state of the asset 12. The set of I/O devices 40 also can include one or more of various types of communications devices for transmitting data to and/or receiving data from a user 14 (e.g., the owner/operator of the asset 12) and/or one or more third parties 16. For example, the asset 12 can include a communications device, such as a wireless communications device, for communicating some or all of management data 34 (e.g., measurement data) for use by the user 14 and/or third party 16, receive modifications to management data 34 (e.g., adjustments to one or more settings for the operation of the asset 12), receive measurement data from an external data source (e.g., a syndicated data feed), and/or the like, during normal operation of the asset 12. The communications can occur periodically according to a defined schedule, in response to a query received from the user 14, under autonomous decision making by computer system 20, and/or the like.

Additionally, the set of I/O devices 40 can include communications device(s) configured to communicate an error status to the user 14 and/or one or more third parties 16. For example, the same communications device utilized during normal operation can be utilized to transmit an error status to the user 14. When the error status increases a risk to one or more other entities (e.g., vehicles, fixed assets, animals, humans, etc.), the asset 12 can communicate data regarding the error status to one or more third parties 16. For example, in a marine application, the computer system 20 can communicate information regarding the asset 12 to local marine traffic using a medium frequency (MF) radio, high frequency (HF) radio, a Global Maritime Distress and Safety System (GMDSS) device, and/or the like.

Asset 12 also can include a power system 42, which is configured to provide all power for operating devices on the asset 12. Implementation of the power system 42 can vary based on a particular application for which asset 12 is being utilized. In an embodiment, the power system 42 is configured to provide all of the power independent of any external power source (e.g., a power grid). For example, for a deployment for a fixed time period, the power system 42 can comprise a set of batteries capable of providing enough power to operate the various components of the asset 12 for the expected deployment time period. However, for an extended/indefinite period of operation, power system 42 can comprise one or more components configured to generate power from a power source of the environment within which the asset 12 is deployed. For example, illustrative power generation components include a wind turbine, a set of solar cells, a wave/current energy harvester, and/or the like. As is known, the amount of power generated by various power generation components is entirely dependent on the ambient conditions, and therefore can vary based on time of day, time of year, physical location (e.g., latitude), weather, and/or the like. To this extent, the power system 42 can include sufficient power storage to continue to operate the components of the asset 12 while power generation capabilities are lower, and can include a generation solution that is capable of re-charging the power storage while also operating the components of the asset 12.

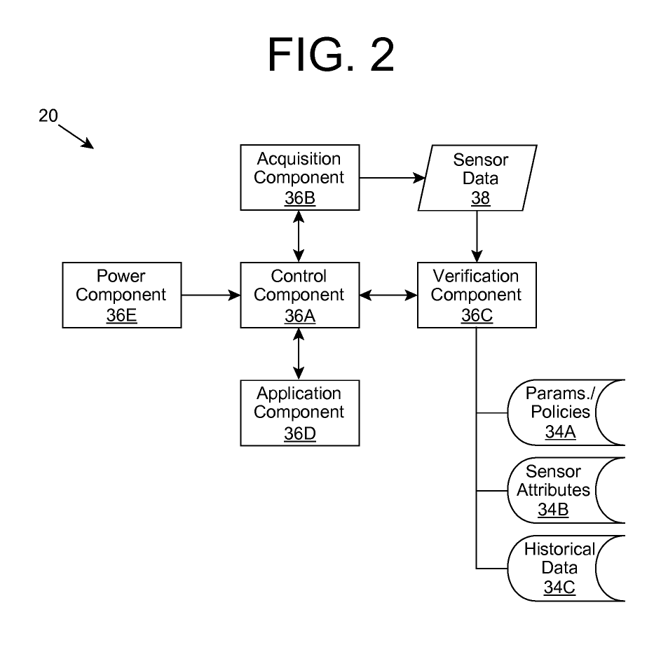

In general, computer system 20 can evaluate the sensor data 40 provided by the I/O devices 40, and manage operation of the set of I/O devices 40 accordingly. To this extent, FIG. 2 shows an illustrative computer system 20 comprising various components 36A-36E according to an embodiment. As illustrated, computer system 20 can comprise a control component 36A, which is configured to receive information from various other components 36B-36E and control operation of some or all of the various other components 36B-36E, such as components 36B-36D. In particular, the control component 36A can receive one or more of: raw sensor data 38 corresponding to one or more attributes of the environment of the corresponding asset 12 (FIG. 1) from an acquisition component 36B; verified sensor data 38 and/or verification results from a verification component 36C; data corresponding to power generation/availability from a power component 36E; measurement data from an application component 36D; and/or the like. Control component 36A can process the data to manage the operation of one or more of the components 36B-36D, including providing data corresponding to any error (e.g., warning or alarm) conditions, if present, using application component 36D.

Acquisition component 36B can acquire sensor data 38 from various I/O devices 40 (FIG. 1) using any solution. For example, acquisition component 36B can be configured to read and/or request sensor data 38 from one or more of the I/O devices 40 according to a predetermined acquisition period. The acquisition period can vary based on the particular I/O device 40 and/or a mode of operation for the asset 12 (FIG. 1). In order to acquire the sensor data 38, acquisition component 36B can manage the operation of one or more of the I/O devices 40. For example, acquisition component 36B can regulate power provided to the I/O devices 40 so that valid sensor data is provided by the I/O devices 40 without having the I/O devices 40 unnecessarily consume a significant amount of power.

Similarly, power component 36E can obtain power data corresponding to an amount of power currently available, an amount of power being generated, and/or the like, from the power system 42 (FIG. 1). Additionally, the power data can include data corresponding to an amount of power currently being consumed by operating some or all of the various I/O devices 40. Computer system 20 can store the power data as management data 34 using any solution, e.g., records in a table, for further processing.

Furthermore, application component 36D can process sensor data 38, receive and/or send data from/to various I/O devices 40, adjust operation of one or more I/O devices 40, and/or the like according to an application to which the asset 12 is directed. For example, the application component 36D can process the sensor data 38 to evaluate one or more attributes of the environment in which the asset 12 is located. In response to the processing, the application component 36D can store the sensor data 38 and/or processed data derived therefrom as management data 34 for later processing, adjust operation of one or more of the I/O devices 40, transmit an alert message in response to one or more of the evaluated attributes, and/or the like. To this extent, application component 36D can send and/or receive data to one or more remote systems, such as a system of a user 14 (FIG. 1) or a third party 16 (FIG. 1), using any solution. Application component 36D can send/receive data according to a predetermined schedule, in response to one or more events (e.g., an alarm condition), and/or the like.

When an I/O device 40 is malfunctioning, the sensor data 38 received by acquisition component 36B can be invalid. In this case, control component 36A can adjust operation of acquisition component 36B to stop operating the I/O device 40, stop acquiring data from the I/O device 40, and/or the like. Similarly, control component 36A can adjust operation of application component 36D to stop processing of the invalid sensor data 38 prior to application component 36D initiating one or more actions with respect to the invalid sensor data 38.

To this extent, sensor data 38 acquired by acquisition component 36B can be evaluated by a verification component 36C prior to processing by control component 36A and/or application component 36D. Verification component 36C can evaluate all of the sensor data 38 acquired for one or more of the I/O devices 40 or evaluate a sampling (e.g., according to a predetermined or dynamically calculated frequency) of the sensor data 38 acquired for one or more of the I/O devices 40. Verification component 36C can use management data 34 (FIG. 1) to perform the evaluation using any solution. For example, the management data 34 can include data 34A regarding the quality parameters and/or evaluation policies corresponding to an I/O device 40, data 34B regarding one or more attributes of the I/O device 40, historical data 34C acquired by the I/O device 40, and/or the like. Verification component 36C can utilize some or all of the management data 34 to evaluate the quality of the sensor data 38.

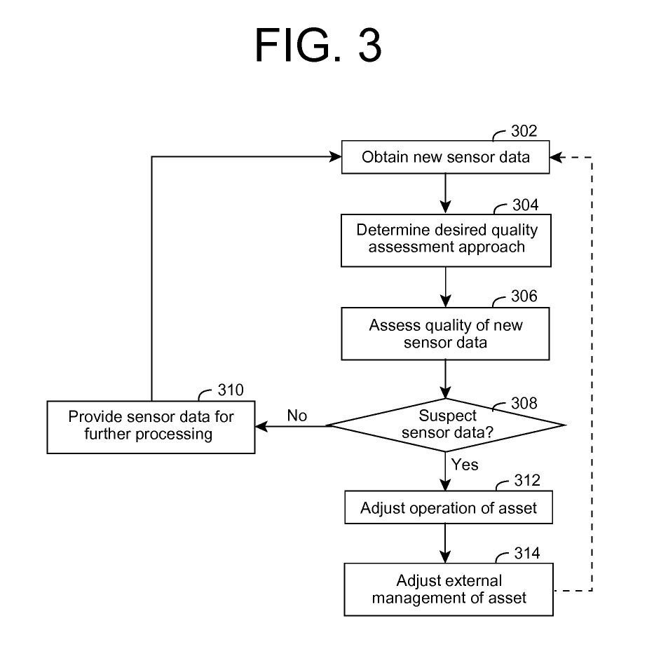

FIG. 3 shows an illustrative flow diagram for evaluating sensor data 38 acquired on an asset 12 (FIG. 1), which can be implemented by computer system 20 (e.g., control component 36A and/or verification component 36C), according to an embodiment. Referring to FIGS. 2 and 3, in process 302, computer system 20 (e.g., verification component 36C) obtains new sensor data 38 for evaluation. As discussed herein, verification component 36C can evaluate all sensor data 38 acquired by the computer system 20 for a sensing device, a subset (e.g., a sampling) of the sensor data 38 acquired for a sensing device, and/or the like. Similarly, verification component 36C can evaluate some or all of the sensor data 38 acquired for all sensing devices or a subset of the sensing devices included on the asset 12. Furthermore, verification component 36C can implement an approach for concurrently evaluating the sensor data 38 acquired from multiple sensing devices (e.g., a group of complementary sensing devices), an approach for evaluating the sensor data 38 acquired by a single sensing device, and/or the like. The amount of sensor data 38 evaluated by the verification component 36C can be selected according to the risk (e.g., physical risk, cost/ease of correction, cost/likelihood of unnecessary action, risk associated with inaction, and/or the like) of invalid sensor data 38 being evaluated and further processed within the environment 10 (FIG. 1).

In an embodiment, an amount of sensor data 38 evaluated by the verification component 36C is initially set by a user 14, or the like. Computer system 20 (e.g., control component 36A) can dynamically adjust the type and/or amount of sensor data 38 evaluated by the verification component 36C according to one or more operating variables of the asset 12. For example, control component 36A can direct verification component 36C to evaluate sensor data 38 acquired from an older sensing device, which may be approaching an end of its operating life, or a sensing device exhibiting one or more indications of possibly failing (e.g., weaker signals, wider variance in measurements, and/or the like) more frequently than that of a newer sensing device. Furthermore, when asset 12 is subjected to a significant event, such as a storm, maintenance, a collision, and/or the like, control component 36A can direct verification component 36C to temporarily evaluate an increased amount of the sensor data 38 to determine whether the various I/O devices 40 are properly operating. Similarly, asset 12 may include one or more inoperable sensing devices in a group of complementary sensing devices. In this case, sensor data 38 acquired from an operating sensing device in the group of complementary sensing devices may have an increased importance. As a result, control component 36A can direct verification component 36C to increase a frequency with which the sensor data 38 acquired from the operating sensing device is evaluated until the inoperable sensing device(s) recommences operating/are replaced.

In process 304, computer system 20 (e.g., verification component 36C) can determine a desired quality assessment approach to utilize in evaluating the sensor data 38. For example, management data 34 can include a set of quality parameters and/or evaluation policies 34A, which computer system 20 can utilize to autonomously or semi-autonomously identify and implement the desired quality assessment approach from a plurality of possible quality assessment approaches. The set of parameters and/or policies 34A can be included when the asset 12 is deployed for operation. Furthermore, the set of parameters and/or policies can be updated after deployment, e.g., by a user 14. In this case, the user 14 can manage updating the set of parameters and/or policies 34A during locally performed maintenance of the asset 12 and/or using a remote connection. When updated remotely, a user 14 can use any type of communications protocol to perform the update, such as a browser-based human machine interface (HMI) in communication with the asset 12 using a direct connect, remote network access, and/or the like, communications protocol.

The set of parameters and policies 34A can include any combination of rules and parameters for identifying and implementing a desired quality assessment approach. For example, the parameters and policies 34A for a particular sensor can define a single quality assessment approach that is always used. Alternatively, the set of parameters and policies 34A for a particular sensor can define multiple quality assessment approaches that can be selected according to other relevant parameters that affect the operation and/or evaluation of the sensing device. For example, the relevant parameters can include: ambient conditions, including temperature, lighting (e.g., day/night, ambient/artificial, etc.), vibration, motion/location of the asset 12, and/or the like; additional sensor data 38 available, including data concurrently/recently acquired by one or more complementary sensing devices, which can be used to confirm/corroborate the sensor data 38; availability of sufficient historical sensor data for the sensing device; other actions/processes occurring on the asset 12; a relevance of data available for the assessment (e.g., data currency/timeliness, specificity, etc.), and/or the like. The parameters and policies 34A can define the desired quality assessment approach based on the relevant parameters.

In process 306, computer system 20 (e.g., verification component 36C) can perform the data quality assessment of the new sensor data 38 using the desired quality assessment approach. To this extent, computer system 20 can use other related sensor data 38 and/or relevant management data 34 to evaluate the quality of the new sensor data 38. For example, computer system 20 can use data corresponding to a set of sensor attributes 34B of the sensing device. In an embodiment, the sensor attributes 34B can be obtained and installed on computer system 20 from a data store corresponding to the sensing device. For example, a sensing device can comprise data associated therewith (e.g., present on the sensing device, provided with the sensing device, and/or available from a manufacturer of the sensing device or other source), which defines various sensor-specific characteristics of the sensing device. The characteristics can include various sensor performance characteristics such as, for example, operating parameters of the sensing device, details on interfacing with the sensing device, an acceptable range of data values, etc. In a more particular embodiment, the characteristics are stored on a sensing device using a data format standard, such as SensorML, which computer system 20 can automatically acquire from a newly connected sensing device and process to configure and interface with the sensing device. Additionally, computer system 20 can obtain data corresponding to the operational status of a related device operated in conjunction with the sensing device (e.g., an emitter operated in conjunction with a sensor).

When available, computer system 20 also can use historical data 34C in order to perform a data quality assessment of the new sensor data 38. The historical data 34C can include, for example: data previously acquired by the same sensing device; data previously acquired by a similar sensing device (e.g., a previously utilized sensor device); sensor data previously and/or concurrently acquired by other related sensing devices; and/or the like. The historical data 34C can comprise raw sensor data 38 and/or data summarizing the historical sensor data 38 (e.g., statistics generated from previous sensor data, relationship information for different sensor data, and/or the like).

Regardless, computer system 20 can evaluate the new sensor data 38 using the desired quality assessment approach in conjunction with the applicable sensor attributes 34B and/or historical data 34C. The evaluation can include one or more of any type of data comparisons and/or analyses, such as, for example: determination of value(s) outside of a valid range; value(s) changing too rapidly; value(s) conflicting with other data; and/or the like. In an embodiment, the evaluation can indicate whether the sensor data 38 is valid or suspect. In another embodiment, a suspect evaluation can comprise two or more possible results, such as, for example, untrustworthy (e.g., value(s) are questionable, but not certain they are invalid), invalid (e.g., value(s) were determined to be inaccurate or acquired using an errant process), unconfirmed (e.g., insufficient data to evaluate the accuracy), and/or the like. It is understood while several possible results are described herein, any combination of various possible results can be utilized.

Computer system 20 can implement an assessment process that evaluates data relating to the sensor data 38 to evaluate the validity of sensor data 38. For example, computer system 20 can acquire data indicating that one or more emitting devices has failed to operate, thereby making any sensor data 38 acquired by the corresponding sensing device invalid. In another illustrative example, asset 12 can include a chemical sensor, which utilizes an automated sampling technology with micro-fluidics, pumps, and reagents to provide sensor data 38. Computer system 20 can acquire and analyze a set of signal characteristics corresponding to the operation of the chemical sensor. Particular signal characteristics can indicate that the chemical sensor followed an erroneous process, which yields incorrect data. However, the sensor data 38 could be within physically sensible ranges for the chemical sensor and the particular application of the chemical sensor. By analyzing the signal characteristics of the chemical sensor, computer system 20 can detect the irregularity and flag the sensor data 38 as invalid.

In process 308, computer system 20 (e.g., control component 36A) can initiate and/or perform one or more different actions based on the evaluation result for the sensor data 38. When the evaluation indicates that the sensor data 38 is likely valid, in process 310, computer system 20 can provide the sensor data for further processing. For example, computer system 20 (e.g., application component 36D) can perform application-specific processing of the sensor data 38, which can include storing the sensor data 38, in a raw and/or processed form, for future processing and/or transmission, initiating one or more actions in response to the sensor data 38, and/or the like.

When computer system 20 determines that the sensor data 38 is suspect (e.g., untrustworthy, invalid, unconfirmed, and/or the like), in process 312, computer system 20 (e.g., control component 36A) can adjust one or more aspects of the operation of the asset 12. Computer system 20 can perform any combination of various adjustments based on a certainty measure that the sensor data 38 is invalid, an importance of the sensor data 38, a risk associated with an adjustment, a possible cause of the invalid data, and/or the like. For example, computer system 20 can set a flag indicating suspect data in a record storing the sensor data 38. Furthermore, computer system 20 can generate and store a record of the data quality problem as historical data 34C. The record can indicate, for example, a time the problem was detected, the sensor data 38 indicated as invalid, the quality assessment approach used to detect the problem, additional data used in the evaluation, and/or the like. Such a record can subsequently be provided to a user 14 for use in evaluating the operating condition of the asset 12 and/or for audit purposes. Similarly, computer system 20 can process a set of records of data quality problems to determine whether to initiate any further actions. For example, a particular sensing device may be known to provide sporadic invalid sensor data 38. In this case, computer system 20 can take minimal action in response to occasional receipt of invalid sensor data, but can initiate additional action when invalid sensor data is received more frequently.

Computer system 20 can determine whether or not a sensing device is inoperable. For example, computer system 20 can evaluate ancillary sensor data, such as data acquired regarding one or more operating conditions (e.g., wind, movement, etc.), to determine whether the invalid sensor data 38 may have been caused by a temporary condition. If so, computer system 20 can wait until the temporary condition passes before operating the sensing device, continue operating the sensing device while monitoring all of its data, and/or the like. However, computer system 20 can fail to determine any possible external cause of the invalid sensor data 38. In this case, computer system 20 can adjust the onboard operation of the sensing device and/or one or more related devices. For example, computer system 20 can initiate a reset procedure corresponding to the sensing device and/or one or more related devices. The reset procedure can include, for example, cycling power provided to a device. Similarly, when available, the reset procedure can include computer system 20 operating an onboard cleaning mechanism to try and return a sensing device and/or one or more related devices that may be clogged/fouled to an operating condition. Additionally, a sensing device can be operated as part of an emitter/sensor pair. In this case, when sensor data 38 indicates that one of the devices is not operating, computer system 20 can shut down the other device in the pair to conserve energy, operating life of the device, and/or the like. Similarly, computer system 20 can adjust operation of other devices in response to an inoperable device, e.g., increasing a frequency with which sensor data 38 is obtained from a sensing device, initiating a failover procedure to switch to an operational sensing device of the same type, accessing data acquired by multiple other sensing devices of different types to determine (e.g., derive, calculate, estimate, and/or the like) a data value for the attribute, adjusting the type of sensor data 38 acquired from a sensing device, and/or the like.

Computer system 20 also can adjust one or more aspects of its interaction with a user 14, third party 16, and/or the like. For example, computer system 20 can suppress the transmission of some or all of the sensor data 38 for processing by the user 14, transmit data indicating that certain sensor data 38 is unavailable, and/or the like. In an embodiment, computer system 20 can suppress the transmission of any sensor data 38 when a threshold amount of the sensor data 38 is evaluated as being invalid. Additionally, computer system 20 can attempt to re-acquire sensor data 38 from a set of sensing devices prior to transmitting sensor data 38, an error message, and/or the like. Similarly, computer system 20 can adjust the operation of one or more local output devices that communicate information to a local third party 16, such as a radio/light beacon, or the like, to indicate an operating status of the asset 12, e.g., that asset 12 is currently unable to monitor one or more attributes of the environment, on which the third party 16 may rely.

In process 314, computer system 20 can adjust one or more aspects of the external management of the asset 12 in response to a determination that the sensor data 38 is suspect. For example, computer system 20 can adjust the time and/or actions for a scheduled maintenance to be performed for the asset 12. Additionally, computer system 20 can provide the invalid sensor data 38 to a maintenance system, which can evaluate the sensor data 38 and determine the required maintenance action(s) and/or timing. The time frame for the maintenance can be adjusted based on an importance of the invalid sensor data 38. To this extent, when an asset 12 is located at a fixed location, an inability to detect drift may require urgent maintenance since inadvertent drift can cause all other sensor data to be invalid despite the sensor data 38 being evaluated as valid. Regardless, if computer system 20 has not shut down the sensing device and/or the sensing device is not entirely inoperable, the process can be repeated for subsequently obtained sensor data.

In an illustrative application, asset 12 can comprise a remote sensor platform for monitoring, for example, water quality using a combination of sensing devices for acquiring data regarding physical, chemical, and/or biological parameters of the water. Asset 12 can be used to acquire sensor data 38 used for managing the natural resource (e.g., a coastal region, river, bay, and/or the like), public health and safety, and/or the like. Asset 12 can operate in an autonomous manner, e.g., relying exclusively on power generated locally from, for example, a set of solar panels that charge batteries. Asset 12 can communicate with other systems (e.g., user 14 and/or third party 16) using any combination of one or more wireless communication solutions, such as radio and/or satellite links.

During normal operation of the asset 12, computer system 20 can acquire and log sensor data 38 from the set of sensors in a predetermined manner and transmit the sensor data 38 for processing by a user 14 at specified times/time intervals, in response to an interrogation, and/or the like. As the sensor data 38 is acquired and logged, computer system 20 can monitor the quality of the sensor data 38 using a set of locally stored data quality parameters and quality assessment approaches and policies as described herein. When computer system 20 determines that sensor data 38 is suspect or invalid, computer system 20 can initiate one or more actions in response to the determination. For example, computer system 20 can: prevent the sensor data 38 from being logged, transmitted, and/or the like; generate a record of the invalid/suspect sensor data 38; communicate a status of the asset 12 for use by a third party 16, a user 14 (e.g., a maintenance system), and/or the like; initiate onboard actions, such as rerunning a sensor data acquisition process, initiating a cleaning/reset procedure, adjusting the operation of one or more related devices, and/or the like.

As described herein, embodiments of asset 12 and/or computer system 20 can provide various benefits over existing implementations of assets 12. For example, computer system 20 can ensure that invalid sensor data 38 is never transmitted from asset 12, thereby lowering the transmission load and cost (e.g., both to local power consumption and processing by other systems). Similarly, computer system 20 can enable the asset 12 to autonomously or semi-autonomously factor sensor characteristics and adjust the operation of sensing devices accordingly using intelligent processing located at or near the sensing devices. By handling and addressing problems as close as possible to the sensing device, the volume of the data stream provided for external processing and the complexity of its processing can be reduced. To this extent, external processing systems can rely on the data quality of the sensor data 38 received, without risk of unnecessarily triggering alarms and other actions related to public health, safety, and/or asset safety.

While shown and described herein as a method and system for managing a movable asset 12, such as a platform, it is understood that aspects of the invention further provide various alternative embodiments. For example, in one embodiment, the asset 12 comprises a “smart” sensor having a set of I/O devices and computer system 20 integrated thereon. In this case, the computer system 20 can include a portion of the components shown in FIG. 2. For example, computer system 20 can be implemented with components 36A-36C. The smart sensor can be implemented as part of a larger system, and can ensure that only valid data is provided from the smart sensor for processing by the larger system. To this extent, use of such a smart sensor can enable the larger system to utilize the sensor data acquired by the smart sensor without requiring knowledge of how and/or resources devoted to ensure the integrity of the sensor data.

In another embodiment, the invention provides a computer program fixed in at least one computer-readable storage medium, which when executed, enables a computer system to manage a movable asset 12. To this extent, the computer-readable storage medium includes program code, such as management program 30 (FIG. 1), which implements some or all of a process described herein. It is understood that the term “computer-readable storage medium” comprises one or more of any type of tangible medium of expression, now known or later developed, from which a copy of the program code can be perceived, reproduced, or otherwise communicated by a computing device. For example, the computer-readable storage medium can comprise: one or more portable storage articles of manufacture; one or more memory/storage components of a computing device; paper; and/or the like.

In another embodiment, the invention provides a method of providing a copy of program code, such as management program 30 (FIG. 1), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable storage medium. In either case, the set of data signals can be transmitted/received using any type of communications link.

In still another embodiment, the invention provides a method of generating an asset 12 (FIG. 1) configured as described herein. In this case, a computer system, such as computer system 20 (FIG. 1), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like. The computer system can be installed on the asset 12 and integrated with the various I/O devices, power system, etc., on the asset 12.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method of managing an asset, the method comprising:
operating a set of sensing devices associated with the asset using a computer system associated with the asset to acquire sensor data, wherein the computer system operates the set of sensing devices independent of a user;
evaluating at least a portion of the sensor data using the computer system, the evaluating including determining whether any sensor data in the at least a portion of the sensor data is suspect; and
initiating an action using the computer system in response to determining at least a portion of the evaluated sensor data is suspect, wherein the action includes at least one of:
adjusting additional processing of the sensor data, adjusting interaction between the computer system and at least one other system remote from the asset, or adjusting management operations of the asset.

2. The method of claim 1, the evaluating further including selecting one of a plurality of quality assessment approaches for sensor data based on a set of quality parameters and an evaluation policy, wherein the evaluation policy identifies a desired one of the plurality of quality assessment approaches for evaluating the sensor data according to the set of quality parameters.

3. The method of claim 2, wherein the set of quality parameters include at least one of: an ambient condition of the asset during which the sensor data was acquired by a corresponding sensing device, an availability of related sensor data acquired by a related sensing device associated with the asset, or an availability of sufficient historical data on the computer system.

4. The method of claim 1, the method further comprising performing further processing of the sensor data using the computer system in response to determining the at least a portion of the evaluated sensor data is valid, the further processing including at least one of: evaluating at least one attribute of an environment of the asset using the sensor data, or providing the sensor data for processing by another system remote from the asset.

5. The method of claim 1, wherein the action includes adjusting additional processing of the sensor data, and wherein the adjusting includes at least one of: setting a flag to indicate the sensor data is suspect, generating historical data corresponding to the suspect sensor data, or preventing further processing of the sensor data by the computer system.

6. The method of claim 1, wherein the action includes adjusting management operations of the asset, and wherein the adjusting includes at least one of: adjusting operation of at least one input/output (I/O) device associated with the asset, initiating a reset procedure for a sensing device associated with the asset, or adjusting at least one aspect of a scheduled maintenance for the asset.

7. The method of claim 1, wherein the action includes adjusting interaction between the computer system and at least one other system remote from the asset, and wherein the action includes at least one of: preventing transmission of the sensor data for processing by another system remote from the asset, transmitting information corresponding to the suspect sensor data for processing by another system remote from the asset, or transmitting information corresponding to an operating status of the asset.

8. A system comprising:
an asset deployed to a desired physical area;
a set of input/output (I/O) devices associated with the asset, the set of I/O devices including a set of sensing devices for acquiring sensor data;
a power system associated with the asset, wherein the power system is configured to provide all power for operating devices associated with the asset; and
a computer system including at least one computing device associated with the asset, wherein the computer system is configured to manage the asset by performing a method including:
operating the set of sensing devices independent of a user to acquire sensor data;
evaluating at least a portion of the sensor data, the evaluating including determining whether any sensor data in the at least a portion of the sensor data is suspect; and
initiating an action in response to determining at least a portion of the evaluated sensor data is suspect, wherein the action includes at least one of: adjusting additional processing of the sensor data, adjusting interaction between the computer system and at least one other system external to the asset, or adjusting management operations of the asset.

9. The system of claim 8, the evaluating further including selecting one of a plurality of quality assessment approaches for sensor data based on a set of quality parameters and an evaluation policy, wherein the evaluation policy identifies a desired one of the plurality of quality assessment approaches for evaluating the sensor data according to the set of quality parameters.

10. The system of claim 8, the method further comprising performing further processing of the sensor data in response to determining the at least a portion of the evaluated sensor data is valid, the further processing including at least one of: evaluating at least one attribute of an environment of the asset using the sensor data, or providing the sensor data for processing by another system remote from the asset.

11. The system of claim 8, wherein the action includes adjusting additional processing of the sensor data, and wherein the adjusting includes at least one of: setting a flag to indicate the sensor data is suspect, generating historical data corresponding to the suspect sensor data, or preventing further processing of the sensor data by the computer system.

12. The system of claim 8, wherein the action includes adjusting management operations of the asset, and wherein the adjusting includes at least one of: adjusting operation of at least one input/output (I/O) device associated with the asset, initiating a reset procedure for a sensing device associated with the asset, or adjusting at least one aspect of a scheduled maintenance for the asset.

13. The system of claim 8, wherein the action includes adjusting interaction between the computer system and at least one other system remote from the asset, and wherein the action includes at least one of: preventing transmission of the sensor data for processing by another system remote from the asset, transmitting information corresponding to the suspect sensor data for processing by another system remote from the asset, or transmitting information corresponding to an operating status of the asset.

14. A computer-readable storage medium comprising program code embodied therein, which when executed, causes a computer system to implement a method of managing an asset, the method comprising:
operating a set of sensing devices associated with the asset to acquire sensor data independent of a user;
evaluating at least a portion of the sensor data, the evaluating including determining whether any sensor data in the at least a portion of the sensor data is suspect; and
initiating an action in response to determining at least a portion of the evaluated sensor data is suspect, wherein the action includes at least one of: adjusting additional processing of the sensor data, adjusting interaction between the computer system and at least one other system remote from the asset, or adjusting management operations of the asset.

15. The storage medium of claim 14, the evaluating further including selecting one of a plurality of quality assessment approaches for sensor data based on a set of quality parameters and an evaluation policy, wherein the evaluation policy identifies a desired one of the plurality of quality assessment approaches for evaluating the sensor data according to the set of quality parameters.

16. The storage medium of claim 14, the method further comprising performing further processing of the sensor data in response to determining the at least a portion of the evaluated sensor data is valid, the further processing including at least one of: evaluating at least one attribute of an environment of the asset using the sensor data, or providing the sensor data for processing by another system remote from the asset.

17. The storage medium of claim 14, wherein the action includes adjusting additional processing of the sensor data, and wherein the adjusting includes at least one of: setting a flag to indicate the sensor data is suspect, generating historical data corresponding to the suspect sensor data, or preventing further processing of the sensor data by the computer system.

18. The storage medium of claim 14, wherein the action includes adjusting management operations of the asset, and wherein the adjusting includes at least one of: adjusting operation of at least one input/output (I/O) device associated with the asset, initiating a reset procedure for a sensing device associated with the asset, or adjusting at least one aspect of a scheduled maintenance for the asset.

19. The storage medium of claim 14, wherein the action includes adjusting interaction between the computer system and at least one other system remote from the asset, and wherein the action includes at least one of: preventing transmission of the sensor data for processing by another system remote from the asset, transmitting information corresponding to the suspect sensor data for processing by another system remote from the asset, or transmitting information corresponding to an operating status of the asset.

20. A method of deploying an asset, the method comprising:
providing a computer system associated with the asset, wherein the computer system is configured to manage the asset by performing a method including:
operating a set of sensing devices associated with the asset to acquire sensor data independent of a user;
evaluating at least a portion of the sensor data, the evaluating including determining whether any sensor data in the at least a portion of the sensor data is suspect; and
initiating an action in response to determining at least a portion of the evaluated sensor data is suspect, wherein the action includes at least one of: adjusting additional processing of the sensor data, adjusting interaction between the computer system and at least one other system remote from the asset, or adjusting management operations of the asset.
